(19) United States
(12) Patent Application Publication
(10) Pub. No.: US 2026/0342156 A1
(43) Pub. Date: Oct. 29, 2026

(54) INTEGRATED OR SPLIT-TYPE ANTI-THERMAL EXPANSION MOTOR FOR ROBOTS

(71) Applicant: Guangdong JEO Co., Ltd., Dongguan (CN)

(72) Inventor: Xiaolong XU, Dongguan (CN)

(21) Appl. No.: 19/652,545

(22) Filed: Apr. 20, 2026

(30) Foreign Application Priority Data
Apr. 24, 2025 (CN) 202510524908.0
Apr. 24, 2025 (CN) 202510524909.5

(51) Int. Cl. H02K 1/2789; B25J 9/12; H02K 5/02; H02K 5/04

(52) U.S. Cl. CPC H02K 1/2789; B25J 9/126; H02K 5/02; H02K 5/04

(57) ABSTRACT

An integrated or split-type anti-thermal expansion motor for robots includes a housing. An installing cavity is provided in the housing, a stator assembly is disposed in the installing cavity, a rotor assembly is sleeved in the stator assembly, the rotor assembly includes a magnetic conductive ring, a magnet ring is sleeved outside the magnetic conductive ring, a shaft sleeve is disposed in the magnetic conductive ring, the shaft sleeve is sleeved on a rotating shaft, and an expansion counteracting structure is disposed on the magnetic conductive ring and used for counteracting thermal expansion of the rotating shaft. When the inner shaft expands due to heat generation during operation of the motor, the expansion counteracting structure on the magnetic conductive ring is no longer a rigid whole but forms a flexible structure similar to elasticity.

### CROSS-REFERENCE TO RELATED APPLICATIONS

The present disclosure claims the priority to the two Chinese patents with the filing number No. 202510524908.0, filed on Apr. 24, 2025, and the filing number No. 202510524909.5, filed on Apr. 24, 2025, the contents of which are incorporated herein in the entirety by reference.

### TECHNICAL FIELD

The disclosure belongs to the technical field of motors, and particularly relates to an integrated or split-type anti-thermal expansion motor for robots.

### BACKGROUND OF THE DISCLOSURE

A motor refers to an electromagnetic device that converts or transmits electric energy according to the law of electromagnetic induction. The rotor of a robot motor is its rotating part, which is responsible for interacting with the stator of the robot motor to convert electric power into mechanical force, thereby driving the movement of the robot. The outer rotor of a robot motor refers to a type of motor whose rotor part can be exposed, and its rotor part is located outside the motor and rotates around the stator. This type of motor is also usually called a coreless motor, and outer rotor motors are generally used in high-speed and high-precision application fields, such as robots, industrial automation, medical equipment, etc.

For example, Chinese utility model with the publication number CN221728013U discloses a rotor of a robot motor, which includes a motor outer rotor, the outer side of the motor outer rotor is connected with a convex rib, the motor outer rotor includes a rotor body, the interior of the rotor body is provided with a top clamping groove, the surface of the top clamping groove is connected with a primary clamping ring, the interior of the primary clamping ring is provided with a secondary clamping groove, the surface of the secondary clamping groove is provided with a middle action plate, the interior of the middle action plate is provided with an internal clamping groove, and one side of the convex rib is provided with a magnetic steel bonding area. By arranging the motor outer rotor, the top clamping groove and the secondary clamping groove inside the rotor body provide space conditions for subsequent installation, and combined with the middle action plate and the internal clamping groove, the whole motor outer rotor can be installed according to specific use environments, facilitating cooperative use. The rotor of a robot motor provides an outer rotor device for robot motors, providing conditions for flexible adjustment, and improving use efficiency and experience.

In the rotor structure, the gap between the rotor and the stator is called an air gap. The smaller the air gap, the greater the torque. Motors in the robot field strive to reduce the air gap for high torque. However, the motor will generate heat during operation, causing the inner shaft to expand, thereby affecting the outer magnetic conductive ring and magnet ring to deform, damage or burst. At the same time, due to the too small air gap, wall friction will occur with the outer stator, affecting the service life of the motor.

### SUMMARY OF THE DISCLOSURE

The object of the disclosure is to provide an integrated or split-type anti-thermal expansion motor for robots, aiming to solve the problem in the above background art that “the motor will generate heat during operation, causing the inner shaft to expand, thereby affecting the outer magnetic conductive ring and magnet ring to deform, damage or burst, and at the same time, due to the too small air gap, wall friction will occur with the outer stator, affecting the service life of the motor”.

To achieve the above object, the integrated or split-type anti-thermal expansion motor for robots provided by the embodiment of the disclosure includes a housing; an installing cavity is provided in the housing, a stator assembly is disposed in the installing cavity, a rotor assembly is sleeved in the stator assembly, the rotor assembly includes a magnetic conductive ring, a magnet ring is sleeved outside the magnetic conductive ring, a shaft sleeve is disposed in the magnetic conductive ring, the shaft sleeve is sleeved on a rotating shaft, the magnet ring is integrally formed or assembled in a split structure, and an expansion counteracting structure is disposed on the magnetic conductive ring and used for counteracting thermal expansion of the rotating shaft.

Optionally, the expansion counteracting structure is a plurality of expansion groove groups, uniformly arranged around the circumferential direction of the magnetic conductive ring.

Optionally, each expansion groove group includes a first groove and a second groove disposed perpendicular to the circumferential direction; the first groove and the second groove are arranged in a crossed manner, one end of each of the first groove and the second groove is communicated with the end part of the magnetic conductive ring, and the other end is not communicated with the other end part of the magnetic conductive ring; the first groove and the second groove are through grooves.

Optionally, each expansion groove group includes a first groove and a second groove disposed perpendicular to the circumferential direction; the first groove and the second groove are arranged on the same straight line, one end of each of the first groove and the second groove is respectively communicated with the end part of the magnetic conductive ring, and the other ends are not communicated with each other, and the first groove and the second groove are through grooves.

Optionally, each expansion groove group also includes a third groove disposed perpendicular to the circumferential direction; both ends of the third groove are not communicated with the end parts of the magnetic conductive ring, and the third groove is a through groove.

Optionally, the shaft sleeve is made of a lightweight material with a low expansion coefficient.

Optionally, the material of the shaft sleeve selects from one of plastic, carbon fiber, ceramic, aluminum alloy, and titanium alloy.

Optionally, a front cover and a rear cover are disposed on the housing, shaft holes are provided in the front cover and the rear cover, and two ends of the rotating shaft respectively pass through the two shaft holes; heat dissipation holes are further provided in the front cover and the rear cover and used for heat dissipation of the motor.

Optionally, a circle of hollow inner edges protrudes from the middle parts of the inner sides of the front cover and the rear cover, a placing position is provided between the inner walls of the inner edges and the rotating shaft, and a bearing is disposed on the placing position.

Optionally, a first slot is provided at one end of the rotating shaft, a gear is disposed at the end of the first slot, a second slot is provided in the inner wall of the gear, and one end of a positioning piece is inserted into the first slot, and the other end is inserted into the second slot.

Compared with the prior art, one or more of the above technical solutions in the integrated or split-type anti-thermal expansion motor for robots provided by the embodiment of the disclosure have at least the following technical effects:

By arranging the expansion counteracting structure for counteracting thermal expansion of the rotating shaft, when the inner shaft expands due to heat generation during operation of the motor, the expansion counteracting structure on the magnetic conductive ring is no longer a rigid whole but forms a flexible structure similar to elasticity. The magnetic conductive ring can adapt to the increase of the diameter of the rotating shaft through the expansion counteracting structure, avoiding rigid extrusion, so that the magnetic conductive ring and the magnet ring will not be deformed, damaged, or burst, and will not rub against the outer stator due to deformation, which affects the service life of the motor.

### BRIEF DESCRIPTION OF THE DRAWINGS

To more clearly illustrate the technical solutions of the embodiments of the disclosure, the following briefly introduces the drawings required for the embodiments. It should be understood that the following drawings only show some embodiments of the disclosure, and therefore should not be regarded as limiting the scope. For those of ordinary skill in the art, other related drawings can be obtained according to these drawings without creative work.

FIG. 1 is a perspective view of the integrated or split-type anti-thermal expansion motor for robots according to one embodiment of the disclosure.

FIG. 2 is an exploded view of the integrated or split-type anti-thermal expansion motor for robots shown in FIG. 1.

FIG. 3 is a perspective view of the assembled segmented magnet ring according one embodiment of the disclosure.

FIG. 4 is a structural schematic diagram of the magnetic conductive ring according to one embodiment of the disclosure.

FIG. 5 is a structural schematic diagram of the magnetic conductive ring according to another embodiment of the disclosure.

FIG. 6 is a structural schematic diagram of the magnetic conductive ring according to another embodiment of the disclosure.

### REFERENCE SIGNS DESCRIPTION

100, Housing;
110. installing cavity;
120. Rotating shaft;
121. First slot;
130. Front cover;
131. Inner edge;
132. placing position;
133. Heat dissipation hole;
140. Rear cover;
150. Shaft hole;
160. Bearing;
170. Gear;
171. Second slot;
180. Positioning piece;
200. Stator assembly;
210. Circuit board;
300. Rotor assembly;
310. Magnetic conductive ring;
311. Expansion groove group;
3111. First groove;
3112. Second groove;
3113. Third groove;
312. Expansion groove;
320. Magnet ring;
330. Shaft sleeve.

### DETAILED DESCRIPTION OF ILLUSTRATED EMBODIMENTS

The embodiments of the disclosure are described in detail below, and examples of the embodiments are shown in the accompanying drawings, wherein the same or similar reference signs represent the same or similar elements or elements with the same or similar functions throughout. The embodiments described below with reference to the accompanying drawings are exemplary and are intended to explain the embodiments of the disclosure, but should not be construed as limiting the disclosure.

In the description of the embodiments of the disclosure, it should be understood that the terms “length”, “width”, “upper”, “lower”, “front”, “rear”, “left”, “right”, “vertical”, “horizontal”, “top”, “bottom”, “inner”, “outer” and other indicated orientations or positional relationships are based on the orientations or positional relationships shown in the accompanying drawings, which are only for the convenience of describing the embodiments of the disclosure and simplifying the description, rather than indicating or implying that the referred device or element must have a specific orientation, be constructed and operated in a specific orientation, and therefore should not be construed as limiting the disclosure.

In addition, the terms “first” and “second” are used for descriptive purposes only and cannot be understood as indicating or implying relative importance or implicitly indicating the number of indicated technical features. Thus, a feature defined with “first” and “second” may explicitly or implicitly include one or more of these features. In the description of the embodiments of the disclosure, “a plurality of” means two or more, unless otherwise specifically and clearly defined.

In the embodiments of the disclosure, unless otherwise clearly specified and limited, the terms “installation”, “connection”, “connection”, “fixation” and other terms should be understood in a broad sense. For example, it can be a fixed connection, a detachable connection, or an integral body; it can be a mechanical connection or an electrical connection; it can be a direct connection or an indirect connection through an intermediate medium, and it can be the internal communication between two elements or the interaction relationship between two elements. For those of ordinary skill in the art, the specific meanings of the above terms in the embodiments of the disclosure can be understood according to specific situations.

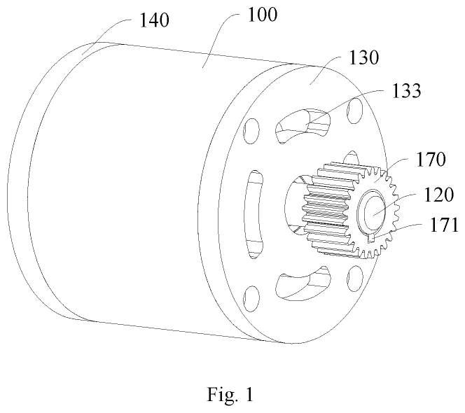

In one embodiment of the disclosure, as shown in FIGS. 1-6, it includes a housing 100; an installing cavity 110 is provided in the housing 100, a stator assembly 200 is disposed in the installing cavity 110, a rotor assembly 300 is sleeved in the stator assembly 200, the rotor assembly 300 includes a magnetic conductive ring 310, a magnet ring 320 is sleeved outside the magnetic conductive ring 310, a shaft sleeve 330 is disposed in the magnetic conductive ring 310, the shaft sleeve 330 is sleeved on a rotating shaft 120, and an expansion counteracting structure is disposed on the magnetic conductive ring 310 and used for counteracting thermal expansion of the rotating shaft 120.

Specifically, by providing the expansion counteracting structure for counteracting thermal expansion of the rotating shaft 120, when the inner shaft expands due to heat generation during operation of the motor, the expansion counteracting structure on the magnetic conductive ring 310 is no longer a rigid whole but forms a flexible structure similar to elasticity. The magnetic conductive ring 310 can adapt to the increase of the diameter of the rotating shaft 120 through the expansion counteracting structure, avoiding rigid extrusion, so that the magnetic conductive ring 310 and the magnet ring will not be deformed, damaged or burst, and will not rub against the outer stator due to deformation, which affects the service life of the motor.

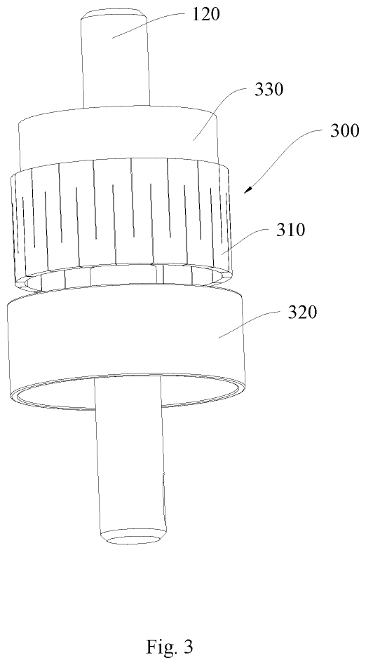

Furthermore, in one embodiment, as shown in FIG. 3, the magnet ring 320 is integrally formed. The integrated magnet ring 320 has a high cost and is suitable for high-precision, low torque ripple, high-speed, or high-reliability scenarios.

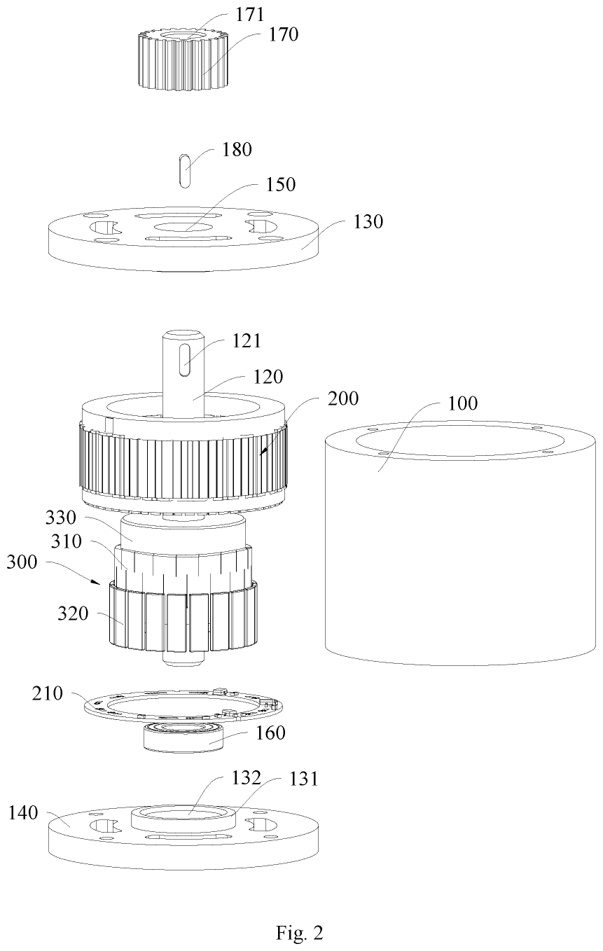

Furthermore, in another embodiment, as shown in FIG. 2, the magnet ring 320 is assembled in a split structure. The assembled and split magnet ring 320 has a low cost and high maintenance convenience, and the magnetic field can be optimized by changing the arrangement of magnetic blocks according to requirements. The assembled and split type is that a plurality of magnets are assembled into the magnet ring 320 by adhesive bonding.

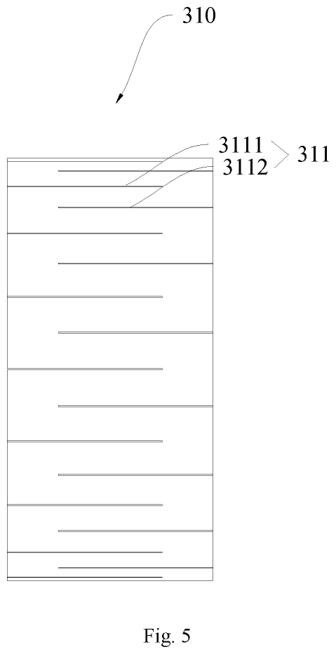

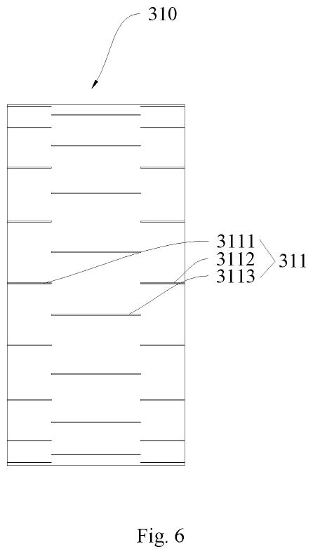

In another embodiment of the disclosure, as shown in FIGS. 5 and 6, the expansion counteracting structure is a plurality of expansion groove groups 311, which are uniformly arranged around the circumferential direction of the magnetic conductive ring 310.

Specifically, the expansion groove groups 311 make the magnetic conductive ring 310 no longer a rigid whole but form a flexible structure similar to a “spring”. When the rotating shaft 120 expands, the magnetic conductive ring 310 can counteract and adapt to the increase in the diameter of the rotating shaft 120 through the slight closing of the expansion groove groups 311, avoiding rigid extrusion.

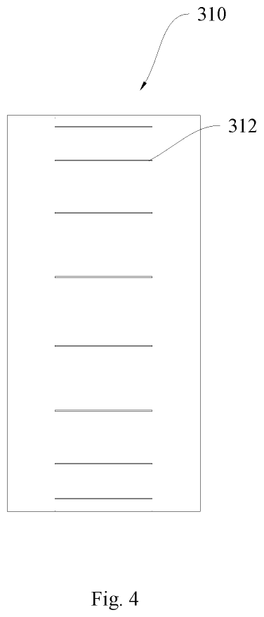

Further, in another embodiment, as shown in FIG. 4, the expansion counteracting structure is a plurality of expansion grooves 312, uniformly arranged around the circumferential direction of the magnetic conductive ring 310, and each expansion groove 312 is disposed perpendicular to the circumferential direction; both ends of the expansion groove 312 are not communicated with the end parts of the magnetic conductive ring 310, and the expansion groove 312 is a through groove.

Furthermore, the expansion counteracting structure is a plurality of expansion groove groups 311, uniformly arranged around the circumferential direction of the magnetic conductive ring 310. The expansion groove groups 311 include but are not limited to the following two embodiments.

One is shown in FIG. 5, each expansion groove group 311 includes a first groove 3111 and a second groove 3112 disposed perpendicular to the circumferential direction; the first groove 3111 and the second groove 3112 are arranged in a crossed manner, one end of each of the first groove 3111 and the second groove 3112 is communicated with the end part of the magnetic conductive ring 310, and the other end is not communicated with the other end part of the magnetic conductive ring 310; the first groove 3111 and the second groove 3112 are through grooves.

The other is shown in FIG. 6, each expansion groove group 311 includes a first groove 3111 and a second groove 3112 disposed perpendicular to the circumferential direction; the first groove 3111 and the second groove 3112 are arranged on the same straight line, one end of each of the first groove 3111 and the second groove 3112 is respectively communicated with the end part of the magnetic conductive ring 310, and the other ends are not communicated with each other, and the first groove 3111 and the second groove 3112 are through grooves. Each expansion groove group 311 also includes a third groove 3113 disposed perpendicular to the circumferential direction; both ends of the third groove 3113 are not communicated with the end parts of the magnetic conductive ring 310, and the third groove 3113 is a through groove. Specifically, as a preferred embodiment, by arranging the parallel first groove 3111 and second groove 3112, the stress on the left and right sides is relatively uniform, and the third groove 3113 is arranged in the middle, which can make the anti-thermal expansion capability stronger. The more and evenly distributed grooves, the greater the elastic force to counteract the diameter expansion of the rotating shaft 120, the less likely the magnetic conductive ring 310 is to be damaged and burst, and the less likely it is to deform, so that the external magnet ring 320 is not easy to deform, and the rotor assembly 300 is not easy to rub against the external stator assembly 200, improving the service life of the motor.

It can be understood that the expansion groove groups 311 of the above two embodiments can achieve the function of counteracting thermal expansion of the rotating shaft 120, and other expansion groove groups 311 including but not limited to three grooves, four grooves, etc. All are within the protection scope of the disclosure.

Furthermore, the first groove 3111 and the second groove 3112 must be arranged symmetrically or crosswise, and cannot be designed only on one side, or in the middle and one side. Otherwise, when the rotating shaft 120 thermally expands, the stress on the left and right sides will be uneven, causing cracking or deformation.

It can be understood that the elastic magnetic conductive ring 310 can reduce the cumulative tolerance of the motor, and the elastic part can be installed in a tight fit without reserving installation fit space.

In another embodiment of the disclosure, as shown in FIGS. 1-3, the shaft sleeve 330 is made of a lightweight material with a low expansion coefficient. The material of the shaft sleeve 330 selects from one of plastic, carbon fiber, ceramic, aluminum alloy, and titanium alloy. Specifically, using a lightweight material can reduce the inertia of the motor rotor, thereby achieving a high response speed of the motor.

In another embodiment of the disclosure, as shown in FIGS. 1-3, a front cover 130 and a rear cover 140 are disposed on the housing 100, shaft holes 150 are provided in the front cover 130 and the rear cover 140, and two ends of the rotating shaft 120 respectively pass through the two shaft holes 150; heat dissipation holes 133 are further provided in the front cover 130 and the rear cover 140 and used for heat dissipation of the motor. Specifically, there are a plurality of heat dissipation holes 133, which can improve the heat exchange efficiency with the outside.

In another embodiment of the disclosure, as shown in FIG. 2, a circle of hollow inner edges 131 protrudes from the middle parts of the inner sides of the front cover 130 and the rear cover 140, a placing position 132 is formed between the inner walls of the inner edges 131 and the rotating shaft 120, and a bearing 160 is disposed on the placing position 132. Specifically, the inner edges 131 are disposed to reserve a special placing position 132 for the bearing 160, so that the bearing 160 can be placed in the placing position 132.

In another embodiment of the disclosure, as shown in FIGS. 1 and 2, a first slot 121 is provided at one end of the rotating shaft 120, a gear 170 is disposed at the end of the first slot 121, a second slot 171 is provided in the inner wall of the gear 170, and one end of a positioning piece 180 is inserted into the first slot 121, and the other end is inserted into the second slot 171. Specifically, by arranging the positioning piece 180, the rotational force of the rotating shaft 120 can be directly transmitted to the gear 170, preventing relative rotation between the two (avoiding slipping). At the same time, the positioning piece 180 plays a centering role during installation, ensuring the angle alignment between the gear 170 and the rotating shaft 120.

In another embodiment of the disclosure, as shown in FIG. 2, a circuit board 210 is further disposed on the stator assembly 200, and the circuit board 210 is used to realize closed-loop control of position, speed, and torque.

The above content is a further detailed description of the disclosure in combination with specific preferred embodiments, and it cannot be considered that the specific implementation of the disclosure is limited to these descriptions. For those of ordinary skill in the technical field to which the disclosure belongs, a number of simple deductions or substitutions can be made without departing from the concept of the disclosure, which should be regarded as falling within the scope of patent protection determined by the submitted claims of the disclosure.

What is claimed is:

1. An integrated or split-type anti-thermal expansion motor for robots, comprising:
a housing; an installing cavity being provided in the housing, wherein a stator assembly being disposed in said installing cavity, a rotor assembly being sleeved in said stator assembly, said rotor assembly includes a magnetic conductive ring, a magnet ring is sleeved outside said magnetic conductive ring, a shaft sleeve is arranged in said magnetic conductive ring, said shaft sleeve is sleeved on a rotating shaft, said magnet ring is integrally formed or assembled in a split structure, and an expansion counteracting structure is disposed on said magnetic conductive ring and used for counteracting thermal expansion of said rotating shaft.

2. The integrated or split-type anti-thermal expansion motor for robots according to claim 1, wherein said expansion counteracting structure is a plurality of expansion groove groups uniformly arranged around said circumferential direction of said magnetic conductive ring.

3. The integrated or split-type anti-thermal expansion motor for robots according to claim 2, wherein each expansion groove group includes a first groove and a second groove disposed perpendicular to said circumferential direction; said first groove and said second groove are arranged in a crossed manner, one end of each of said first groove and said second groove is communicated with one end part of said magnetic conductive ring, and the other end of each of said first groove and said second groove is not communicated with the other end part of the magnetic conductive ring; said first groove and said second groove are through grooves.

4. The integrated or split-type anti-thermal expansion motor for robots according to claim 2, wherein each expansion groove group includes a first groove and a second groove disposed perpendicular to said circumferential direction; said first groove and said second groove are arranged on the same straight line, one end of each of said first groove and said second groove is respectively communicated with the end part of the magnetic conductive ring, and the other ends are not communicated with each other, and said first groove and said second groove are through grooves.

5. The integrated or split-type anti-thermal expansion motor for robots according to claim 4, wherein each expansion groove group also includes a third groove disposed perpendicular to said circumferential direction; both ends of said third groove are not communicated with said end parts of said magnetic conductive ring, and said third groove is a through groove.

6. The integrated or split-type anti-thermal expansion motor for robots according to claim 1, wherein said shaft sleeve is made of a lightweight material with a low expansion coefficient.

7. The integrated or split-type anti-thermal expansion motor for robots according to claim 6, wherein said material of said shaft sleeve selects from one of plastic, carbon fiber, ceramic, aluminum alloy, and titanium alloy.

8. The integrated or split-type anti-thermal expansion motor for robots according to claim 1, wherein a front cover and a rear cover are disposed on said housing, shaft holes are provided in said front cover and said rear cover, and two ends of said rotating shaft respectively pass through said two shaft holes; heat dissipation holes are further provided in said front cover and said rear cover and used for heat dissipation of said motor.

9. The integrated or split-type anti-thermal expansion motor for robots according to claim 8, wherein a circle of hollow inner edges protrudes from said middle parts of said inner sides of said front cover and said rear cover, a placing position is provided between said inner walls of said inner edges and said rotating shaft, and a bearing is arranged on said placing position.

10. The integrated or split-type anti-thermal expansion motor for robots according to claim 1, wherein a first slot is provided at one end of said rotating shaft, a gear is disposed at said end of said first slot, a second slot is provided in said inner wall of said gear, and one end of a positioning piece is inserted into said first slot, and said other end is inserted into said second slot.
